(19) United States
(12) Patent Application Publication
(10) Pub. No.: US 2007/0229440 A1
(43) Pub. Date: Oct. 4, 2007

(54) SOURCE DRIVER OF AN LCD PANEL WITH REDUCED VOLTAGE BUFFERS AND METHOD OF DRIVING THE SAME

(76) Inventor: Chih-Jen Yen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/425,378

(22) Filed: Jun. 20, 2006

(30) Foreign Application Priority Data
Mar. 30, 2006 (TW) 095111297

(51) Int. Cl. G09G 3/36

(52) U.S. Cl. 345/100

(57) ABSTRACT

A source driver for driving an M-bit liquid crystal display panel includes a reference voltage generator, 2^{M-X} voltage buffers and a voltage-dividing circuit. The 2^{M-X} voltage buffers are coupled to the reference voltage generator for enhancing the driving abilities of 2^{M-X} reference voltages generated by the reference voltage generator, thereby generating corresponding 2^{M-X} output voltages. The voltage-dividing circuit is coupled to the 2^{M-X} voltage buffers for voltage-dividing the 2^{M-X} output voltages generated by the 2^{M-X} voltage buffers, thereby generating 2^{M} reference voltages required for driving the M-bit liquid crystal display panel.

### BACKGROUND OF THE INVENTION

1. Field of the Invention

The present invention relates to an LCD source driver and method of driving the same, and more particularly, to an LCD source driver with reduced voltage buffers and method of driving the same.

2. Description of the Prior Art

Liquid crystal display (LCD) devices are flat panel displays characterized by thin appearance, low radiation and low power consumption. LCD devices have gradually replaced traditional cathode ray tube (CRT) displays, and been widely applied in various electronic products such as notebook computers, personal digital assistants (PDAs), flat panel televisions, or mobile phones. An LCD device usually includes an LCD panel, a timing controller, a gate driver, and a source driver. The timing controller generates data signals corresponding to display images, together with control signals and clock signals for driving the LCD panel. The source driver generates driving signals based on the data signals, the control signals and the clock signals received from the timing controller.

Reference is made to FIG. 1 for a prior art of LCD source driver 10 for driving an M-bit and N-channel LCD panel. The LCD source driver 10, capable of generating N output voltages OUT(1)-OUT(N), includes a first line latch 11, a second line latch 12, a shift register 13, a level shifter 14, a decoder 15, a reference voltage generator 16, and a voltage buffering circuit 17. The first line latch 11, the second line latch 12, the shift register 13, the level shifter 14 and the decoder 15 each include N channels, respectively corresponding to the N output voltages OUT(1)-OUT(N) generated by the LCD source driver 10.

In the LCD source driver 10, the shift register 13 is triggered by a clock signal CLK and a control signal CT1, the first line latch 11 is triggered by an enabling signal ENA generated by the shift register 13, the second line latch 12 is triggered by a control signal CT2, and the voltage buffering circuit 17 is triggered by an output enabling signal OE. If the LCD source driver 10 is triggered by signals having a high logic level (logic 1), the shift register 13 and the voltage buffering circuit 17 output data when receiving a logic 1 trigger signals, while the line latches 11 and 12 latch data when receiving a logic 1 trigger signals.

When the clock signal CLK and the control signal CT1 both have high logic levels, the shift register 13 sequentially outputs the enabling signal ENA comprising a plurality of logic 1 pulses to the first line latch 11. The first line latch 11 sequentially receives N M-bit input signals Din1-DinN, and sequentially latches the input signals Din1-DinN when the enabling signal ENA has a high logic level. The second line latch 12 is coupled to the first line latch 11. After the input signals Din1-DinN are completely latched by the first line latch 11, the control signal CT2 switches to a high logic level so that the input signals Din1-DinN can be simultaneously latched by the second line latch 12. The level shifter 14, coupled to the second line latch 12 and the decoder 15, receives the input signals Din1-DinN latched by the second line latch 12 and adjusts the voltage levels of the input signals Din1-DinN, thereby turning on the switches in the decoder 15 which respectively correspond to the output voltages OUT(1)-OUT(N). The voltage buffering circuit 17 can enhance the driving abilities of the 2^{M} reference voltages generated by the reference voltage generator 16, so that the output voltages OUT(1)-OUT(N) can reach predetermined analog output voltage levels.

Reference is made to FIG. 2 for an enlarged diagram illustrating the reference voltage generator 16 and the voltage buffering circuit 17 of the prior art of LCD source driver 10. The purpose of the voltage buffering circuit 17 is to enhance the driving abilities of the output signals. For example, in an M-bit LCD panel, the reference voltage generator 16 generates 2^{M} reference voltages Vref(1)-Vref(2^{M}). In the prior art of LCD source driver 10, the voltage buffering circuit 17 includes 2^{M} voltage buffers that receive the 2^{M} reference voltages Vref(1)-Vref(2^{M}) from respective input ends of the reference voltage generator 16, and output the corresponding 2^{M} reference voltages Vr(1)-Vr(2^{M}) having enhanced driving abilities to respective output ends.

The circuit space occupied by the voltage buffering circuit 17 increases with the number of the voltage buffers included. With increasing demands for high-resolution displays, an LCD device needs more voltage buffers. For example, a source driver for an 8-bit LCD panel needs to include 256 voltage buffers. Therefore, in the prior art of LCD device, the voltage buffering circuit 17 occupies a lot of circuit space and adds to manufacturing costs.

### SUMMARY OF THE INVENTION

The claimed invention provides an LCD source driver with reduced voltage buffers for driving an M-bit LCD panel comprising a reference voltage generator for generating 2^{M-X} reference voltages, 2^{M-X} voltage buffers coupled to the reference voltage generator for respectively enhancing driving abilities of the 2^{M-X} reference voltages and thereby generating corresponding 2^{M-X} output voltages, and a voltage-dividing circuit coupled to the 2^{M-X} voltage buffers for voltage-dividing the 2^{M-X} output voltages generated by the 2^{M-X} voltage buffers and thereby generating 2M driving voltages required for operating the M-bit LCD panel.

The claimed invention also provides a method for generating 2M driving voltages for an M-bit LCD panel using 2^{M-X} voltage buffers comprising outputting 2^{M-X} reference voltages to 2^{M-X} voltage buffers, the 2^{M-X} voltage buffers enhancing driving abilities of the 2^{M-X} reference voltages and thereby generating corresponding 2^{M-X} output voltages, and generating 2M driving voltages required for operating the M-bit LCD panel by voltage-dividing the 2^{M-X} output voltages.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a prior art of LCD source driver for driving an M-bit and N-channel LCD panel.

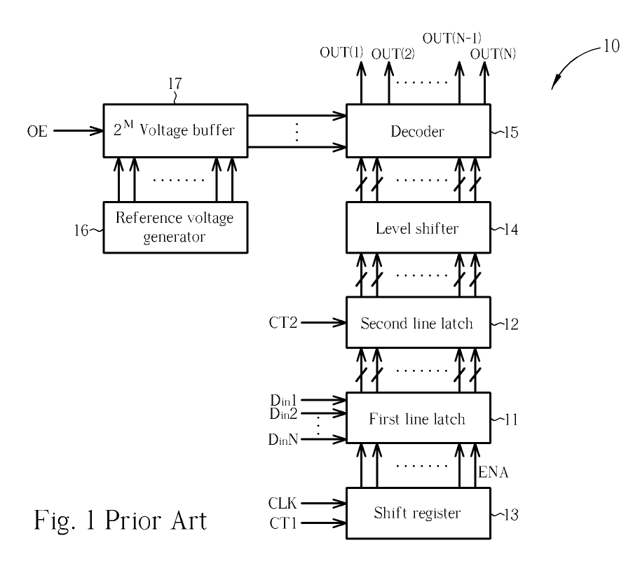

FIG. 2 is an enlarged diagram illustrating the LCD source driver in FIG. 1.

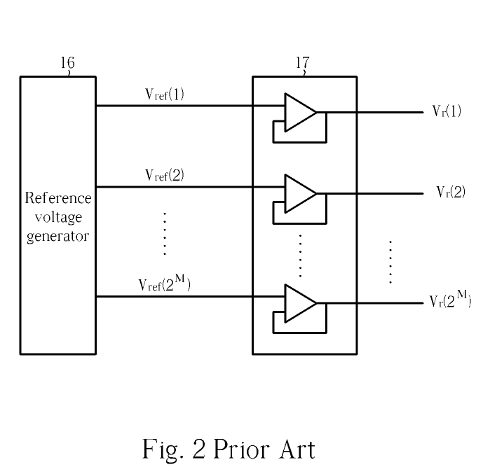

FIG. 3 shows an LCD source driver for driving an M-bit and N-channel LCD panel according to the present invention.

FIG. 4 is an enlarged diagram illustrating the LCD source driver in FIG. 3.

### DETAILED DESCRIPTION

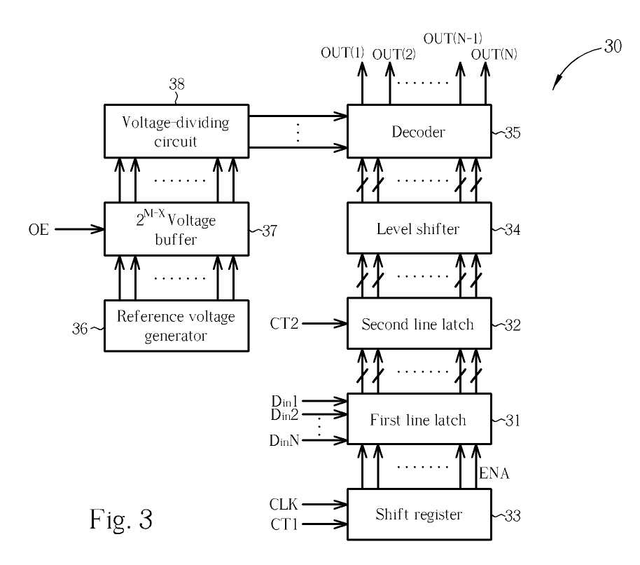

Reference is made to FIG. 3 for an LCD source driver 30 for driving an M-bit and N-channel LCD panel according to the present invention. The LCD source driver 30, capable of generating N output voltages OUT(1)-OUT(N), includes a first line latch 31, a second line latch 32, a shift register 33, a level shifter 34, a decoder 35, a reference voltage generator 36, a voltage buffering circuit 37, and a voltage-dividing circuit 38. The first line latch 31, the second line latch 32, the shift register 33, the level shifter 34 and the decoder 35 each include N channels, respectively corresponding to the N output voltages OUT(1)-OUT(N) generated by the LCD source driver 30. The voltage buffering circuit 37 can enhance the driving abilities of the 2^{M-X} reference voltages generated by the reference voltage generator 36 (X is an integer smaller than M). The voltage-dividing circuit 38 generates 2^{M} reference voltages required for operating the M-bit LCD panel by voltage-dividing the 2^{M-X} reference voltages received from the voltage buffering circuit 37.

In the LCD source driver 30, the shift register 33 is triggered by a clock signal CLK and a control signal CT1, the first line latch 31 is triggered by an enabling signal ENA generated by the shift register 33, the second line latch 32 is triggered by a control signal CT2, and the voltage buffering circuit 37 is triggered by an output enabling signal OE. The clock signal CLK, the control signals CT1 and CT2, and the output enabling signal OE can be generated by a timing controller, while the enabling signal ENA can be generated by the shift register 33 based on the clock signal CLK and the control signal CT1. If the LCD source driver 30 is triggered by signals having a high logic level (logic 1), the shift register 33 and the voltage buffering circuit 37 output data when receiving a logic 1 trigger signals, while the line latches 31 and 32 latch data when receiving a logic 1 trigger signals.

When the clock signal CLK and the control signal CT1 both have a high logic level, the shift register 33 sequentially outputs the enabling signal ENA comprising a plurality of logic 1 pulses to the first line latch 31. The first line latch 31 sequentially receives N M-bit input signals Din1-DinN, and sequentially latches the input signals Din1-DinN when the enabling signal ENA has a high logic level. The second line latch 32 is coupled to the first line latch 31. After the input signals Din1-DinN are completely latched by the first line latch 31, the control signal CT2 switches to a high logic level so that the input signals Din1-DinN can be simultaneously latched by the second line latch 32. The level shifter 34, coupled to the second line latch 32 and the decoder 35, receives the input signals Din1-DinN latched by the second line latch 32 and adjusts the voltage levels of the input signals Din1-DinN, thereby turning on the switches in the decoder 35 which respectively correspond to the output voltages OUT(1)-OUT(N). The reference voltage generator 36 only generates 2^{M-X} reference voltages, whose driving abilities are then enhanced by the voltage buffering circuit 37. The voltage-dividing circuit 38 then generates 2^{M} driving voltages for operating the M-bit LCD panel by voltage-dividing the 2^{M-X} reference voltages received from the voltage buffering circuit 37, so that the output voltages OUT(1)-OUT(N) can reach predetermined analog output voltage levels.

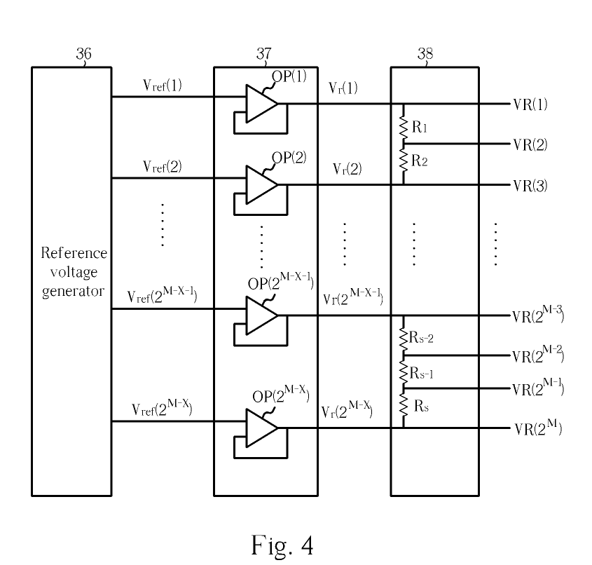

Reference is made to FIG. 4 for an enlarged diagram illustrating the reference voltage generator 36, the voltage buffering circuit 37 and the voltage-dividing circuit 38 of the LCD source driver 30. The purpose of the voltage buffering circuit 37 is to enhance the driving abilities of the output signals. The voltage-dividing circuit 38 can generate more output voltages by performing voltage-division using resistors coupled in series. For an M-bit LCD panel, compared to the 2^{M} reference voltages Vref(1)-Vref(2^{M}) generated by the prior art reference voltage generator 16, the reference voltage generator 36 of the present invention only needs to generate 2^{M-X} reference voltages Vref(1)-Vref(2^{M-X}). Therefore, the voltage buffering circuit 37 of the present invention only needs to include 2^{M-X} voltage buffers OP(1)-OP(2^{M-X}) that receive the 2^{M-X} reference voltages Vref(1)-Vref(2^{M-X}) at respective input ends and output the corresponding 2^{M-X} reference voltages Vr(1)-Vr(2^{M-X}) having enhanced driving abilities at respective output ends. Subsequently, using the resistors R₁-Rₛ of the voltage-dividing circuit 38 for voltage-dividing the 2^{M-X} reference voltages Vr(1)-Vr(2^{M-X}), 2^{M} driving voltages VR(1)-VR(2^{M}) for operating the M-bit LCD panel can thus be generated.

In the embodiment shown in FIG. 4, the voltage-dividing circuit 38 includes a plurality of resistors R₁-Rₛ coupled in series. The number of the resistors R₁-Rₛ is related to the values of M and X. For example, if both ends of the two series-coupled resistors R₁ and R₂ are respectively coupled to the reference voltages Vr(1) and Vr(2), three driving voltages VR(1)-VR(3) can be generated after voltage-division; if both ends of the three series-coupled resistors Rₛ-Rₛ₋₂ are respectively coupled to the reference voltages Vr(2^{M-X-1}) and Vr(2^{M-X}), four driving voltages VR(2^{M-3})-VR(2^{M}) can be generated after voltage-division.

In conclusion, the present invention provides an LCD source driver with reduced voltage buffers for driving an M-bit LCD panel. The circuit space of the source driver and the manufacturing costs can thus be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An LCD source driver with reduced voltage buffers for driving an M-bit LCD panel comprising:
a reference voltage generator for generating 2^{M-X} reference voltages;
2^{M-X} voltage buffers coupled to the reference voltage generator for respectively enhancing driving abilities of the 2^{M-X} reference voltages and thereby generating corresponding 2^{M-X} output voltages; and
a voltage-dividing circuit coupled to the 2^{M-X} voltage buffers for voltage-dividing the 2^{M-X} output voltages generated by the 2^{M-X} voltage buffers and thereby generating 2M driving voltages required for operating the M-bit LCD panel.

2. The source driver of claim 1 further comprising a decoder coupled to the voltage-dividing circuit and the M-bit LCD panel for outputting the 2^{M} driving voltages generated by the voltage-dividing circuit to the M-bit LCD panel according to a control signal.

3. The source driver of claim 2 further comprising:
a shift register for generating enabling signals based on a clock signal and a first control signal;
a first line latch coupled to the shift register for sequentially receiving a plurality of image signals corresponding to display images of the M-bit LCD panel, and latching the plurality of image signals based on the enabling signals received from the shift register;
a second line latch coupled to the first line latch for receiving the image signals latched by the first line latch, and latching the image signals received from the first line latch based on a second control signal; and
a level shifter coupled to the second line latch and the decoder for adjusting voltage levels of the image signals latched by the second line latch and thereby generating the corresponding control signal to the decoder.

4. The source driver of claim 3 further comprising a control circuit for generating the first and second control signals.

5. The source driver of claim 1 wherein the voltage-dividing circuit comprises a plurality of resistors coupled in series between output ends of the 2^{M-X} voltage buffers for voltage-dividing the 2^{M-X} output voltages.

6. The source driver of claim 1 wherein X includes a positive integer.

7. A method for generating 2M driving voltages for an M-bit LCD panel using 2^{M-X} voltage buffers, the method comprising:
outputting 2^{M-X} reference voltages to 2^{M-X} voltage buffers;
the 2^{M-X} voltage buffers enhancing driving abilities of the 2^{M-X} reference voltages and thereby generating corresponding 2^{M-X} output voltages; and
generating 2M driving voltages required for operating the M-bit LCD panel by voltage-dividing the 2^{M-X} output voltages.

8. The method of claim 7 further comprising generating the 2^{M-X} reference voltages.

9. The method of claim 7 wherein voltage-dividing the 2^{M-X} output voltages includes voltage-dividing the 2^{M-X} output voltages using a plurality of resistors coupled in series.

10. The method of claim 7 wherein X includes a positive integer.

11. The method of claim 7 further comprising outputting the 2^{M} driving voltages to the M-bit LCD panel via a decoder.

12. The method of claim 11 further comprising generating a control signal to the decoder based on display images of the M-bit LCD panel.
